(19) United States
(12) Patent Application Publication
(10) Pub. No.: US 2016/0333622 A1
(43) Pub. Date: Nov. 17, 2016

(54) SLIDING DOOR CLOSING DEVICE

(71) Applicant: KOMANDOR S.A., Radom (PL)

(72) Inventors: Mariusz Glogowski, Nidzica (PL); Piotr Szymanski, Kowala-Stepocina (PL)

(73) Assignee: Komandor S.A., Radom (PL)

(21) Appl. No.: 15/112,853

(22) PCT Filed: Jan. 29, 2015
(86) PCT No.: PCT/PL2015/000008

§ 371 Date: Jul. 20, 2016

(30) Foreign Application Priority Data
Jan. 30, 2014 (PL) P.407002

(51) Int. Cl. E05F 3/18; E05F 3/22; E05F 5/02; E05F 1/16; E05F 5/00

(52) U.S. Cl. CPC E05F 3/18; E05F 1/16; E05F 5/003; E05F 5/02; E05F 3/224

(57) ABSTRACT

The sliding door closing device, according to the invention, features an easy door opening function with an opening system comprising: a slider (2) with an attachment (25) and gripper (8) on one side, properly shaped support (5) of the moving roller (10a) on the other side, pusher (13) contacting the roller support (5) of the roller (10a) with a slider gripper (8) and the opening device spring (14) and choke (12). The opening system allows for the opening of a door by pushing the door on a vertical strip or on the edge.

The subject of the invention is a device for closing sliding doors, designed for use in the furniture industry, built-ins and interior arrangement.

Sliding door closing devices prevent the door from closing too fast and hitting against an external frame, side wall or frame. They prevent the hand from being crushed or damage to the door structure.

From patent description US2013167444A1, a sliding door arrangement is known, in which the force of a rapidly closing door is dampened by a gas shock absorber mounted in a guide rail. A pin is attached to the door, which, while closing, engages with a gripper attached at the end of the shock absorber.

From Polish utility model application W.120907, a sliding door closing device is known, which comprises three systems for shock absorbing and gripping, spring tension adjustment and an adjustable device mounting inside the guide rail. While sliding (opening) the door, the shock absorbing and gripping system is tensioned by the spring tension adjustment system, and an engagement pin is released from a driver, and the door continues sliding freely. While closing, the rapidly closing door with the engagement pin hits its driver, the shock absorbing and gripping system is released, the door is braked and energy is dissipated, and the door continues closing slowly, controlled by the spring tension adjustment system, until it closes completely.

Solutions known from the above descriptions are able to brake rapidly closing doors, yet they are difficult to open since, until the shock absorber is released, the resistance of the shock absorbing system has to be overcome. This is particularly difficult for doors without handles or strips intended for opening.

The purpose of the invention was to develop a sliding door closing device that will brake a rapidly sliding door leaf and close it to make contact with a side edge, but would allow easy and effortless opening at the same time.

The door closing device, according to the invention, has a body. The body, in its upper part, has longitudinal holes in the side walls, located in the vicinity of the body ends. In the lower part of the body, there is a longitudinal component located in parallel to the base, which serves as a pusher, and—in the upper part of the body—above the pusher, there is a slider with lateral holes at the ends.

Inside the slider, there are two chambers. In one of them, there is a spring and a choke of the closing device, and in the other chamber, the gripper of the closing device is fixed slidably, connected with the closing device choke and which remains in contact with the closing device spring. The end part of the slider, at the side of spring and choke, is terminated with a hooked attachment. To one of the external walls of the body, the spring—and on the opposite side—the choke of the opening device is mounted. The ends of the spring and choke of the opening device are permanently attached to the body wall and—on the other side—connected with a lateral joiner placed through holes in the body and in the slider. On one of the ends, the body is fitted with the rotary and spring mounted slider gripper, which remains in contact with the pusher, and is provided with an attachment that fits to the one at the end of the slider. On the opposite side of the body, there is a permanently fixed housing, in which there are two rollers arranged in parallel to the body base, whereby one roller is movable and one is stationary. The movable roller is fitted in a support that is spring-mounted to the housing, and its side surface remains in contact with the pusher end.

Preferably, the closing device body has the shape of a channel bar, which, in the cross section, is narrower in the lower part than in the upper part.

The sliding door closing device, according to the invention, features an easy door opening function with an opening system comprising a slider with an attachment and gripper on one side, properly shaped support of the moving roller on the other side, pusher contacting the roller support with a slider gripper, the opening device spring and choke. The opening system allows for opening of the door by pushing the door on a vertical strip or on the edge. Pushing on the door moves the support on the moving roller and simultaneously moves the pusher on the support wedge and releases the pusher from the gripper. In one variant of the door closing device, according to the invention, the pusher releases the slider from the gripper by a pushing movement, and in the other variant, it does so by a pulling movement. By opening the opened door, tension is placed on the closing device spring with the gripper of the closing device moving inside the slider. The stroke of the slider is determined by the length of longitudinal holes in the body. Preferably, the length of the holes is approx. 25 mm. When tension is placed on the spring, the gripper is locked, and the door moves freely on the guide rails. While closing, the closing device gripper is released by the door guide gripper, and the door is closed by placing tension on the opening spring and moving the slider in the body and locking it with the slider gripper at the same time. The closing spring pulls the door to the inner side of the cabinet.

The closing device, according to the invention, is provided with components with the additional function of releasing the door closing system, thanks to which, at first, the door is much easier to open, and activating the opening mechanisms requires only a slight push on the door or on a vertical profile in which the door is fixed.

The sliding door closing device, according to the invention, is presented in a sample embodiment in a drawing, in which

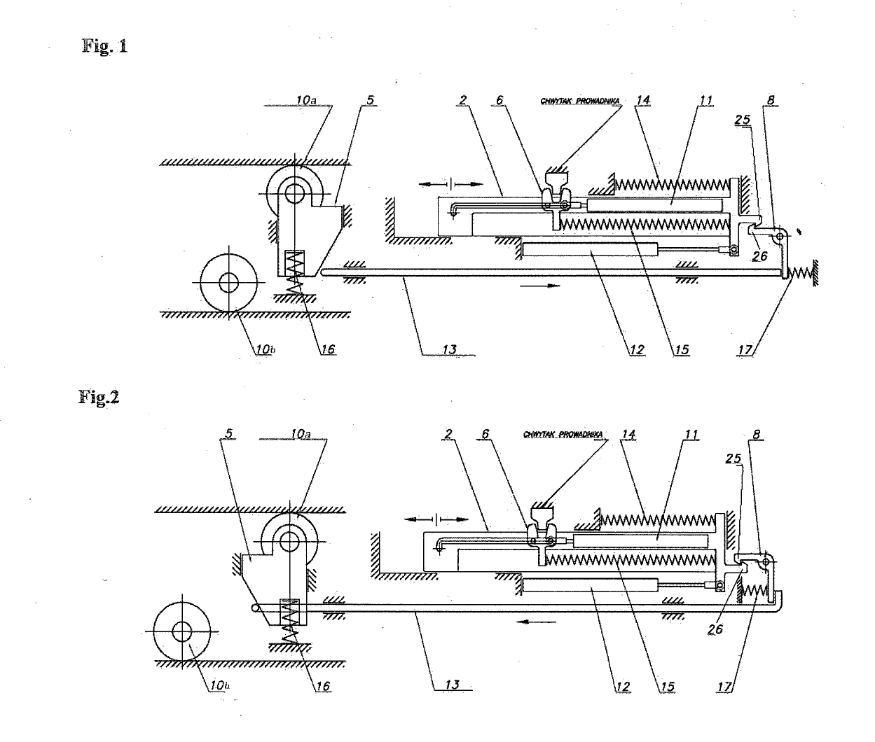

FIG. 1 presents a simplified diagram of the first variant of the device with the door closed,

FIG. 2 presents a simplified diagram of the second variant of the device with the door closed,

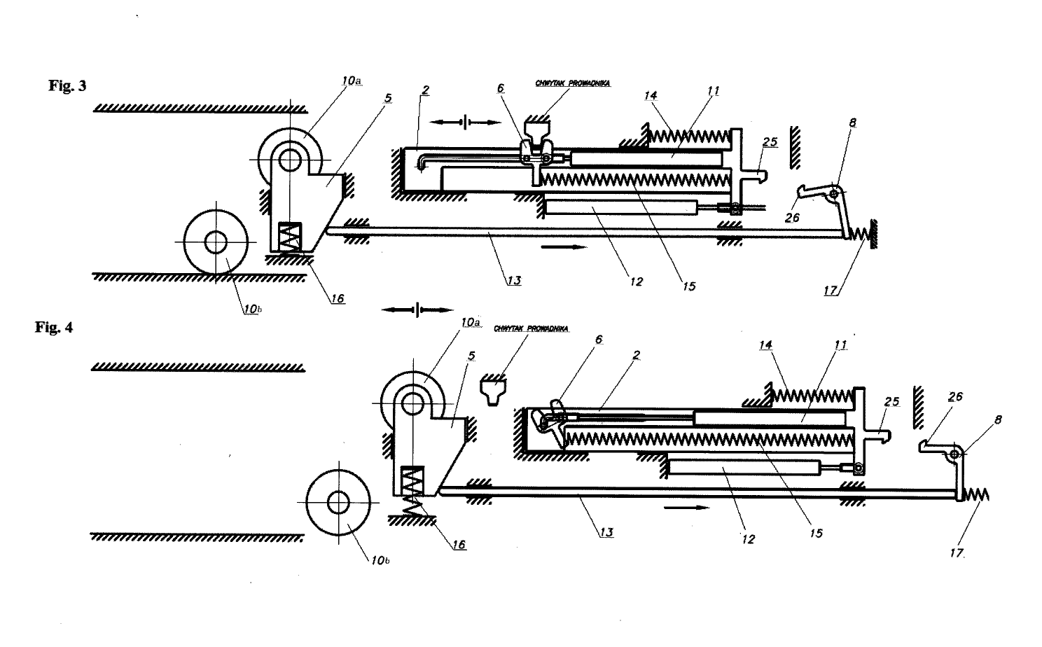

FIG. 3 presents a simplified diagram of the first variant of the device with the door opened,

FIG. 4 presents a simplified diagram of the first variant of the device with the door slid out,

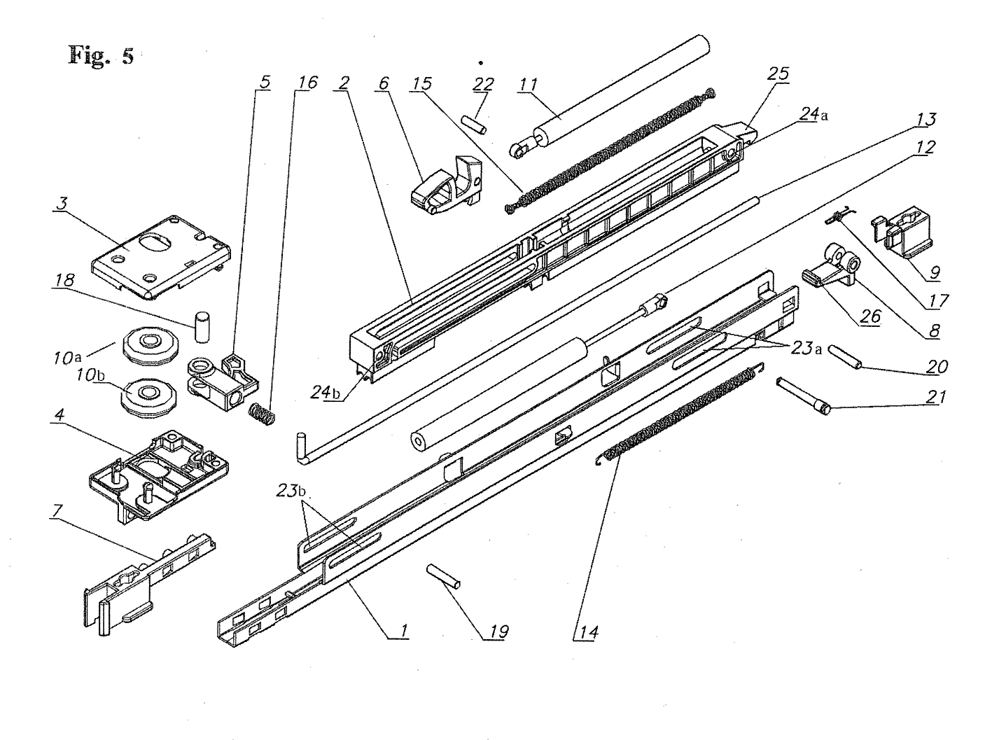

FIG. 5 presents an exploded view of the closing device components in its first variant, and

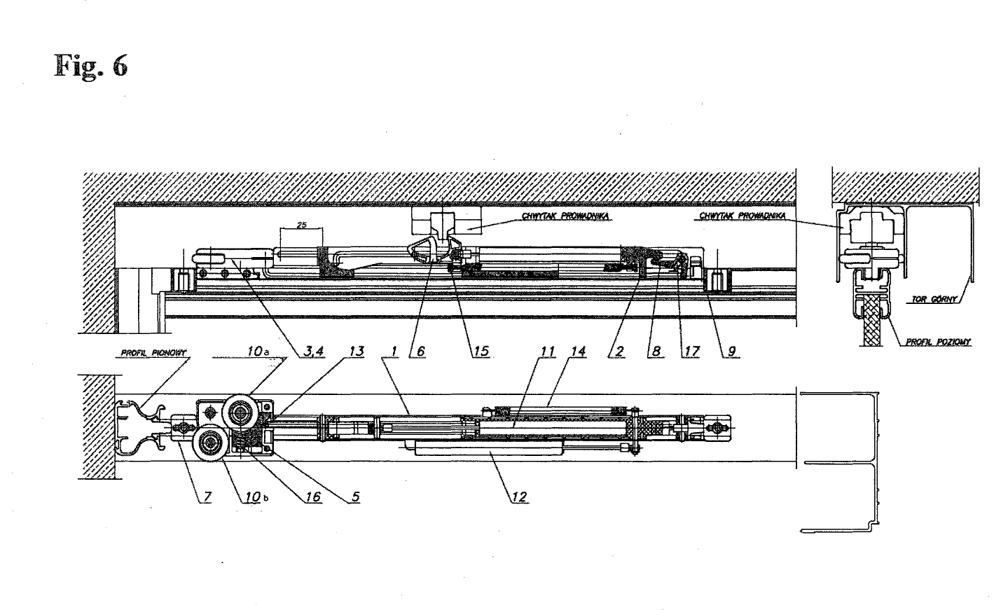

FIG. 6 presents three views of the closing device mounting in the upper track.

A sample embodiment of the first variant of the sliding door closing device according to the invention is presented in the drawing, which has a metallic body 1 in the shape of a channel bar, which, in the cross section, is narrower in the lower part than in the upper part. At the ends of the body 1, there are the starting attachment 7 and end attachment 9. The starting and end attachments are profiled so as to fit to the inner side of the horizontal door profile. The body 1 has four 25 mm long holes 23a and 23b in the side walls of the upper part. In the lower part of the body 1, there is a longitudinal component 13, which serves as a pusher, and—in the upper, wider part of the body—above the pusher 13, there is a slider 2 with holes 24a and 24b at the ends. The slider 2 can travel in the body at the distance of 25 mm, since it is held with pins 19 and 21 placed in the holes 24a and 24b, moving in the holes 23a and 23b of the body 1. Inside the slider 2, there are two chambers. In one of them, there is the spring 15 and the choke 11 of the closing device, and in the other chamber, the gripper 6 of the closing device is fixed slidably, connected with the closing device choke 11 by the pin 22 and which remains in contact with the closing device spring 15. The end part of the slider, at the side of spring 15 and choke 11, is terminated with a hooked attachment 25. To one of the external walls of the body 1, the spring 14 and—on the opposite side—the choke 12 of the opening device is mounted. The ends of the spring 14 and choke of the opening device 12 are permanently attached to the body 1 wall on one side and—on the other side—connected with the pin 21 placed through the holes 23b in the body and through the holes 24b in the slider. At the end part of the body 1, at the end attachment 9, there is a rotary and spring mounted slider gripper 8, which remains in contact with the pusher 13, which is provided with an attachment 26 that fits to the attachment 25 at the end of the slider. The gripper 8 is connected to the body with the pin 20, and the spring 17 holds the slider gripper in the correct position. On the opposite side of the body 1, there is a permanently fixed housing comprising of the top cover 3 and bottom cover 4. Inside the housing, there are two rollers 10a and 10b arranged in parallel to the base of the body 1, whereby the roller 10a is movable, and the roller 10b is stationary. The movable roller 10a is placed in the support 5 with the pin 18 on which it rotates. The support 5 of the roller 10a is held in position by the spring 16. The side surface of the support 5 remains in contact with the end of the pusher 13.

In the second variant, shown in the drawing in FIG. 2, the pusher 13 remains in contact with the opposite side of the support 5, which is a mirror reflection of the support 5 of the first variant. The other end of the pusher 13 remains in contact with the slider gripper 8, which is connected to the body with the pin 20. Since, in this variant, the pusher 13 is pulled by the roller support 5, its end remains in contact with the outer side of the slider gripper 8.

In the initial state, the door rests against the cabinet or wall edge, the closing device spring 15 is released, and tension is created on the opening device spring 14, i.e. it is ready to open the door. Pushing on the side edge of the door or on the profile moves the door leaf in relation to the guide rail. This causes a simultaneous movement of the roller 10a, moves the roller support 5 and pusher 13, whose opposite side interacts with the gripper 8. Simultaneously, the slider gripper 8 turns in an axis perpendicular to the base of the body, thus releasing the slider 2. The released slider 2 moves in the holes cut in the body over a distance of 25 mm thanks to the release of the opening device spring 14. This movement is cushioned with the opening device choke 12. Along with the slider 2 movement, the door is moved away from the framing. When continuing to open the door, the closing device slider gripper 6 is moved, which creates tension on the closing device spring 15 at the same time. Moving along a proper trajectory in the slider, thanks to guides cut in the slider, the closing device gripper 6, when it creates tension on the closing device spring 15 and choke 11, is locked, and the door continues to open freely. While closing the door, the closing device gripper 6 is released in the slider 2 by the guide attachment mounted in the door rail. The slider 2 moves back in the body 1 and creates tension on the opening device spring 14 and choke 12. At the same time, the locked closing device gripper 6 in the slider gripper moves inside the slider 2, being pulled by the closing device spring 15. This causes a pulling of the door to the framing edge. This movement is cushioned by the closing device choke 11 connected with the closing device gripper 6. When the door is pulled, the slider 2 is locked by the slider gripper. The door is ready to open.

In the second variant of the device, the movement of the roller 10a, while pushing, moves the support 5 which pulls the pusher 13. The pusher, being pulled and remaining in contact with the slider gripper, simultaneously causes the gripper 8 to rotate on a perpendicular axis to the body base, but in the opposite location as compared to the first variant. The slider gripper 8 has a hooked attachment on the opposite side as compared to the first variant. Its rotary movement releases the gripper.

1. Sliding door closing device with a body and adjustment and cushioning system, with springs, chokes and attachments, characterised in that in the lower part of the body (1), there is a longitudinal pusher (13) in parallel to its base, and in the upper part of the body (1), there are longitudinal holes (23a, 23b) in its side walls, located near the ends of the body, and above the pusher (13), there is a slider (2) with lateral holes (24a, 24b) at the ends, and inside the slider (2), there are two chambers, whereby in one of them, there is the closing device spring (15) and closing device choke (11), and in the other chamber, there is the closing device gripper (6), mounted slidably, connected with the closing device choke (11) and remaining in contact with the closing device spring (15), and the end of the slider (2), at the side at which there is the closing device spring (15) and closing device choke (11), is terminated with a hooked attachment (25), and on one of the outer sides of the body (1), the opening device spring (14) is attached, and the opening device choke (12) on the opposite side, whereby the ends of the opening device spring (14) and of the choke (12) are on one side permanently attached to the walls of the body (1) and, on the other side, connected with a lateral joiner (21) placed through the holes (23a and 23b) in the body (1) and holes (24a, 24b) in the slider (2), and at one of the ends, the body (1) is provided with a rotary and spring mounted slider gripper (8) remaining in contact with the pusher (13) and provided with an attachment (26) that fits to the attachment (25) at the end of the slider, and on the opposite side of the body (1), there is a permanently fixed housing in which there are two rollers (10a, 10b) arranged in parallel to the body (1) base, whereby the roller (10a) is movable, and the roller (10b) is stationary, and the movable roller (10a) is located in the support (5), which is spring mounted to the housing, and its side surface remains in contact with the end of the pusher (13).

2. Closing device, according to claim 1, characterised in that the body (1) has the shape of a channel bar, which, in the cross section, is narrower in the lower part than in the upper part.
